(19) United States
(12) Patent Application Publication
(10) Pub. No.: US 2012/0041982 A1
(43) Pub. Date: Feb. 16, 2012

(54) METHOD AND SYSTEM FOR ASSOCIATING CO-PRESENCE INFORMATION WITH A MEDIA ITEM

(75) Inventor: Kenneth Jennings, Raleigh, NC (US)

(73) Assignee: KOTA ENTERPRISES, LLC, WILMINGTON, DE (US)

(21) Appl. No.: 12/398,953

(22) Filed: Mar. 5, 2009

Related U.S. Application Data
(60) Provisional application No. 61/122,777, filed on Dec. 16, 2008.

(51) Int. Cl. G06F 17/30

(52) U.S. Cl. 707/784; 707/E17.009; 707/E17.014; 707/785

(57) ABSTRACT

Computer-implemented methods and systems for associating co-presence information with a media item comprise creating a media identification (ID) for the media item in response to a media device acquiring a media item. The media ID is broadcast to at least one peer device co-present with the media device. A transmission is received from a registered user of the peer device reporting receipt of the media record ID, and an arbitrary ID for the registered user is created. The arbitrary ID of the registered user of the peer device that reported receipt of the media record ID is then associated with the media item.

### CROSS-REFERENCE TO RELATED APPLICATIONS

This application claims the benefit of Provisional Patent Application Ser. No. 61/122,777, filed on Dec. 16, 2008, assigned to the assignee of the present application and incorporated herein by reference.

### BACKGROUND

The idea of capturing and embedding co-presence information in media metadata is undoubtedly powerful, given that there is a number of compelling use cases that warrant its development. For example, a context-aware camera phone application for mobile media sharing (MMM2) has been deployed that attempts to overcome difficulties with sharing media from mobile devices, such as camera phones. MMM2 is designed to address three central problems in camera phone use: transferring photos from the phone, finding and managing photos, and sharing the photos. MMM2 is meant to solve these problems by enabling automatic background uploading of camera phone photos to a web-based photo management and sharing application; acquiring system and user created metadata to support photo management and sharing; and automatically suggesting sharing recipients on the phone and in the web application based on sharing frequency and Bluetooth-sensed co-presence of other users.

MMM2 produces and uses metadata to automatically suggest likely sharing recipients. At the time media is captured on the phone, MMM2 automatically records: spatial context in the form of location data through cell ID, Bluetooth-enabled GPS devices, and fixed location Bluetooth objects such as PCs; temporal context; and social context (who is co-present with the phone determined by the association of sensed mobile Bluetooth devices and user names).

After media capture, the user may optionally caption the image, then decide whether to share the image immediately or simply let the camera phone application upload the image to the web in the background. If the user selects the “Share” option, the camera phone application shows the user a list of suggested recipients. The suggested recipients list is currently based on two sets of information: Bluetooth-sensed co-presence and a user's sharing history. The co-presence list may include a list of nearby devices and the stored association of person names and Bluetooth IDs entered by MMM2 users. The selected media is then sent to the device of the selected recipients.

Similarly, patent publication 2007/0255785 assigned to Yahoo! Inc., provides for Multimedia Sharing in Social Networks for Mobile Devices. The system is directed toward sharing multimedia information on a mobile device based on vitality and/or social networking information. After the mobile device receives multimedia information, the multimedia information may be automatically annotated using a geographical location of the mobile device, an identity of a user of the mobile device, and a geographical proximity with another member of a common social network, for example. The multimedia information is then shared automatically with another user based on vitality information of the social networking relationship. The multimedia information may be sent automatically to another mobile device over a device-to-device wireless protocol or a client-server protocol.

Although the two systems described above and other similar systems, expand upon contextual information captured and embedded in media, such as co-presence information about people who were nearby the user at the time the media is captured, such systems have drawbacks that may limit their acceptance and use.

One major drawback is that conventional systems fail to provide users control over their presence information that is embedded in the media, particularly if the presence information contains the identification of the user and/or the co-present users. That is, once a users' presence information is embedded within the media, the users are open to the risk that their presence information may be persisted indefinitely, and shared arbitrarily, especially if the media and the associated presence information are available on a public sharing website. Although this may seem innocuous at first, a potential long-term problem arises when one considers the possibility that users could be tracked over time using the media containing their presence information—a side effect most users would likely protest.

### BRIEF SUMMARY

The exemplary embodiment provides methods and systems for associating co-presence information with a media item. Aspects of exemplary embodiments comprise in response to a media device acquiring a media item, creating of a media identification (ID) for the media item. The media ID is broadcast to at least one peer device co-present with the media device. A transmission is received from a registered user of the peer device reporting receipt of the media record ID, and an arbitrary ID for the registered user is created. The arbitrary ID of the registered user of the peer device that reported receipt of the media record ID is then associated with the media item.

### BRIEF DESCRIPTION OF SEVERAL VIEWS OF THE DRAWINGS

FIG. 1 is a diagram illustrating one embodiment of a system for automatic association of co-presence information with a media item.

FIG. 2 is a flow diagram illustrating one embodiment of a process for associating co-presence information with a media item.

FIGS. 3A and 3B are flow diagrams illustrating one embodiment of a process for associating co-presence information with a media item in further detail.

FIG. 4 is a diagram illustrating an exemplary media record.

FIGS. 5A and 5B are diagrams illustrating an exemplary identification record maintained by the identification server.

### DETAILED DESCRIPTION

The exemplary embodiment relates to associating co-presence information with a media item. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems for associating co-presence information with a media item. Instead of embedding in the media item the identifications of device users who were nearby a device user at the time the user's device acquired the media item, the exemplary embodiments hide or abstract the identifications of the co-present device users by representing the device users with arbitrary ID's. The arbitrary IDs are then associated with the media item as presence information. Each user whose presence information is associated with the media item may configure user preferences that define whether their presence information is shared, and if so, for how long. Consequently, users are given control over how their presence information is shared and persisted.

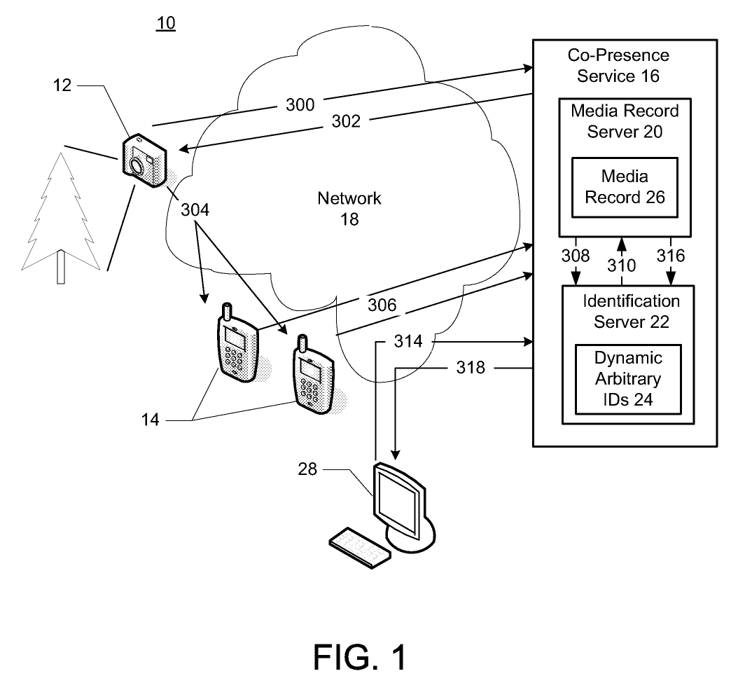

FIG. 1 is a diagram illustrating one embodiment of a system for associating co-presence information with a media item. The system 10 may include a media device 12, peer devices 14, and a co-presence service 16. In one embodiment, the media device 12 is an electronic device that receives media items and that is capable of communicating over a wired or wireless network 18 (e.g., the Internet). The media device 12 may acquire media items through direct capture, directly from another device, or via the network 18. For example, the media device 12 may capture media items, such as digital images and/or video. Or the media device 12 may receive media items over the network 18 in the form of image or music files. The media device 12 may also be portable. Example types of such a media device may include cell phones, personal digital assistants (PDAs), smart phones, digital still and video cameras, media players, wearable devices, scanners, and computers generally, such as laptops, notebooks, tablets and PCs.

The peer devices 14 comprise electronic devices that are considered to be co-present with the media device 12 and are also capable of wired or wireless communication either over the network 18 or directly with the media device 12 (e.g., via Bluetooth). Therefore, the peer devices 14 may comprise the same types of devices as the media device 12 listed above. Both the media device 12 and peer devices 14 include components, such as memory and a processor for executing a client application (not shown). The client application may be configured to communicate with the co-presence service 16 and to implement the below described processes.

The co-presence service 16 may maintain a set of servers accessible over the network 18, which in combination with client application, provide a service for associating co-presence information with the media items. In one embodiment, the co-presence service 16 may include a media record server 20 and an identification server 22.

The identification server 22 may store identification information of registered users of the media device 12 and the peer devices 14, and may obfuscate or abstract that information by generating dynamic arbitrary IDs 24 (hereinafter, arbitrary IDs 24) for the registered users. In one embodiment, the identification server 22 maintains an identification record for each registered user of the system 10 that includes: actual identification information of the registered user, such as an open-ID, a social network profile, and/or an IP or Mac address of a device of the registered user. The identification record may also include a list of the arbitrary IDs 24 that refer to the registered user, and user preference information that defines a term and a context in which the user's dynamic arbitrary IDs 24 are mapped to the user's identification.

The media record server 20 may create a media record 26 for each media item acquired by the media device 12 that identifies the media item as well as the registered users of the media device 12 and of the peer devices 14 that are co-present with the media device 12 during media item acquisition. The media record server 20, however, only identifies the registered users in the media record 26 using the arbitrary IDs 24 to maintain confidentiality of the registered users.

The co-presence service 16 may also accept queries regarding the media items from a requesting entity 28, such as a user of the devices 12 and 14, and a social network, for example. In response, the media record server 20 accesses the media record 26 corresponding to the media item, and queries the identification server 22 with the arbitrary IDs 24. The identification server 22 uses the arbitrary IDs 24 to retrieve and return the identities of the corresponding registered users based on the user preferences of the registered users.

Although the co-presence service 16 is shown with two servers 20 and 22, the co-presence service 16 may include additional servers and components, and the functionality of each of the servers 20 and 22 may be implemented using a lesser or greater number of servers and components.

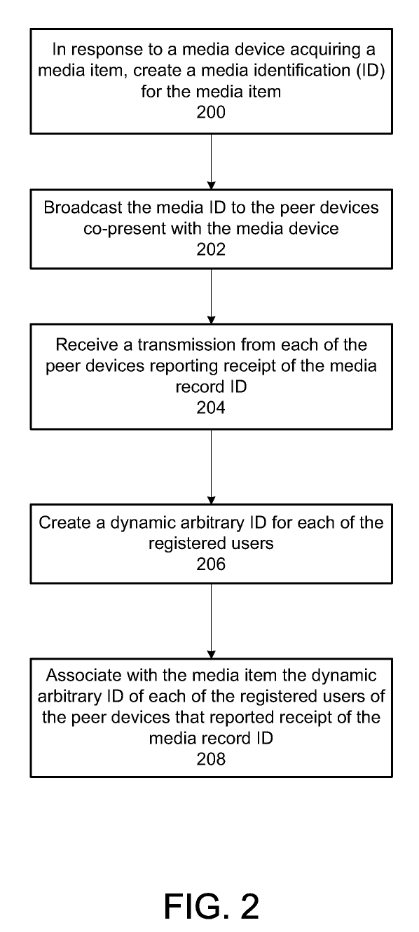

FIG. 2 is a flow diagram illustrating one embodiment of a process for associating co-presence information with a media item. In response to a media device 12 acquiring a media item, a media identification (ID) 26 is created for the media item (block 200). As stated above, the media device 12 may acquire the media item through a media capture event or by receiving the media item. In one embodiment, the co-presence service 16 generates a media record 26 containing the media ID in response to a request from the media device 12. In an alternative embodiment, the media device 12 may generate the media ID and report the media ID to the co-presence service 16. In one embodiment, the media ID may be substantially unique for each media item.

The media ID is then broadcasted to the peer devices 14 co-present with the media device (block 202). In one embodiment, the media device 12 receives the media ID from the co-presence service 16 and then broadcasts the media ID to the peer devices 14 determined to be co-present in a geographic location of the media device 12 at the time the media item was acquired. In an alternative embodiment, the co-presence service 16 may broadcast the media ID directly to the co-present peer devices 14. In one embodiment, the co-presence of the peer devices 14 can be determined using a variety of techniques such as, Bluetooth or Wi-Fi discovery, and a location matching service based on GPS or cell tower triangulation, for example.

A transmission from each registered user of the peer devices is received reporting receipt of the media record ID (block 204). In one embodiment, the co-presence service 16 receives a transmission from each of the peer devices reporting receipt of the media record ID, and each transmission may include a peer ID of the peer device 14. In one embodiment, the peer devices may report receipt of the media record ID to the co-presence service 16 automatically. In an alternative embodiment, the registered users of the peer devices may manually initiate the reporting on the corresponding peer device.

A dynamic arbitrary ID 24 is created for each of the registered users (block 206). In one embodiment, the co-presence service 16 may create the dynamic arbitrary IDs, and use the arbitrary IDs 24 to identify the registered users, rather than use the real identification of the registered users. In one embodiment, the arbitrary IDs are considered dynamic because the co-presence service 16 creates a new dynamic arbitrary ID for each of the respective registered users each time respective peer devices 14 of the registered users report receipt of a new media record ID. Overtime, the identification server 22 may maintain a list of arbitrary IDs 24 associated with individual registered users. In one embodiment, the arbitrary IDs 24 are created only for the users of the peer devices 14. In another embodiment, the arbitrary IDs 24 are created for both the users of the peer devices 14 as well as the user of the media device 12.

In one embodiment, the identification server 22 may store an ID record for each registered user. The ID record may contain the identification of the registered user, a peer device ID for each of the peer devices 14 of the registered user, and the dynamic arbitrary IDs 24 created for the registered user. When the co-presence service 16 receives a transmission from a peer device reporting receipt of the media record ID, the identification server 22 may use the peer device ID from the transmission to find the ID record of the corresponding registered user, and then create the dynamic arbitrary ID for that registered user.

After the dynamic arbitrary ID 24 is created, the dynamic arbitrary ID 24 of each of the registered users of the peer devices 14 that reported receipt of the media record ID are associated with the media item (block 208). In one embodiment, the co-presence service 16 may associate with the media item the dynamic arbitrary ID 24 of each of the registered users. More specifically, the media record server 20 may associate the dynamic arbitrary IDs 24 with the media item by updating the media record 26 containing the media ID of the media item with the dynamic arbitrary IDs returned by the identification server 22.

In one embodiment, the co-presence information may also be associated with the media item by the co-presence service 16 returning the media ID to the media device 12, and the media device 12 automatically embedding the media ID into the media item metadata.

Subsequently, a query may be received from an entity 28 for information about the media item, where the query contains the media ID. In one embodiment, the co-presence service 16 may receive a query. The co-presence service 16 may resolve the query by identifying the arbitrary IDs 24 associated with the media item, and by then identifying the registered users that correspond to the arbitrary IDs. For example, the co-presence service 16 may use the media ID of the media item to lookup the dynamic arbitrary IDs associated with the media item, and then use the dynamic arbitrary IDs to lookup and return the identification of the associated registered users.

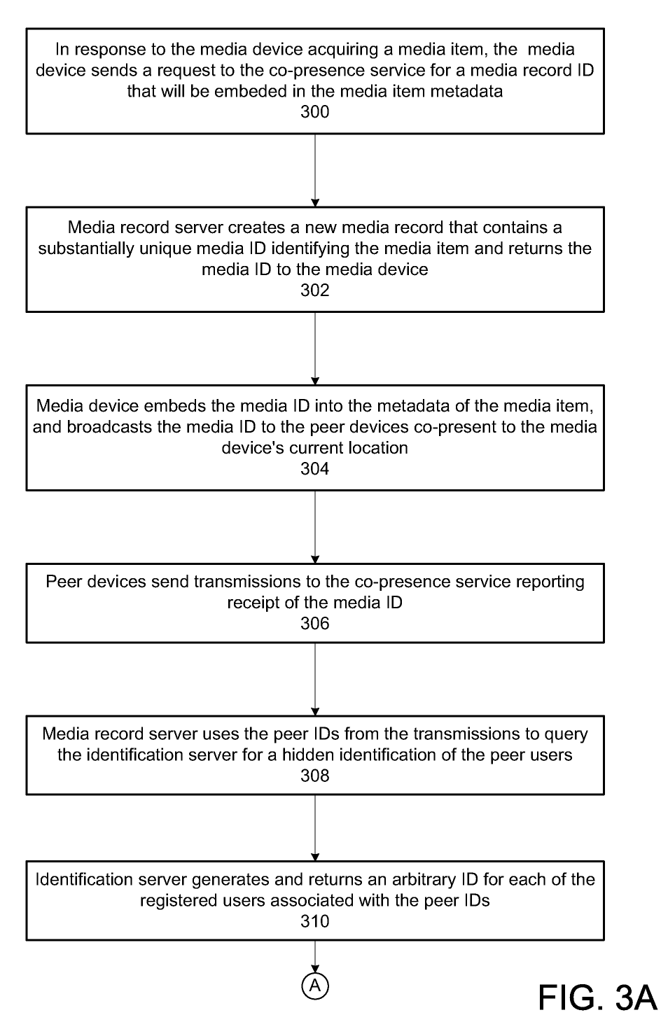

FIGS. 3A and 3B are flow diagrams illustrating one embodiment of a process for associating co-presence information with a media item in further detail. Referring to both FIGS. 1 and 3A, in response to the media device 12 acquiring a media item, such as capturing a picture of a nearby tree, the media device 12 sends a request to the co-presence service 16 for a media record ID that will be embedded in the media item metadata (step 300). The media record server 20 creates a new media record 26 that contains a substantially unique media ID identifying the media item and returns the media ID to the media device 12 (step 302). The media ID may comprise a unique key, for example

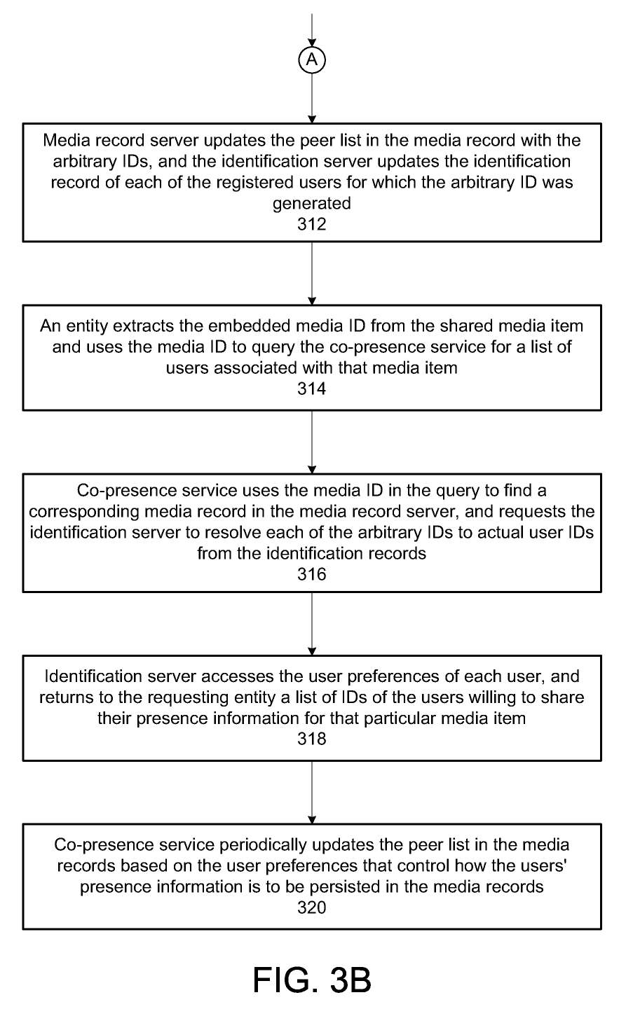

FIG. 4 is a diagram illustrating an exemplary media record. In one embodiment, the media record 26 may comprise a data structure that includes a media ID field 400 for holding the media ID 402 created for a media item, and a peer list 404 for holding the arbitrary IDs 406 that will be generated for the users of the peer devices 14 co-present at the time the media item was acquired. In this example, the media record field 400 is shown storing a media ID having a value of 1 FFXEC, and the peer list 404 is shown storing two arbitrary IDs 406 having values of 23F243 and 23F244.

Referring again to FIG. 3A, after receiving the media ID, the media device 12 embeds the media ID into the metadata of the media item, and broadcasts the media ID to the peer devices 14 co-present to the media device's current location (step 304). Upon receiving the media ID from the media device 12, the peer devices 14 send transmissions to the co-presence service 16 reporting receipt of the media ID (step 306). The transmissions each include the peer ID of the sending peer device 14.

The media record server 20 uses the peer IDs from the transmissions to query the identification server 22 for a hidden identification of the users of the peer devices 14 (step 308). The identification server 22 generates and returns an arbitrary ID for each of the registered users associated with the peer IDs (step 310). Each of the arbitrary IDs 406 map back-to-back to actual identifying information for the corresponding registered user, which is stored only in the identification server 22.

Referring to FIG. 3B, the media record server 20 updates the peer list 404 in the media record 26 with the arbitrary IDs 406, and the identification server 22 updates the identification record of each of the registered users for which the arbitrary ID was generated (step 312).

With the association of co-presence information with the media item, it is now possible for an entity 28 to query the co-presence service 16 for such information. An entity 28 such as users, social networks, or photo sharing web sites, can extract the embedded media ID from the shared media item and use the media ID to query the co-presence service 16 for a list of users associated with that media item (step 314).

The co-presence service 16 uses the media ID in the query to find a corresponding media record 26 in the media record server 20, and requests the identification server 22 to resolve each of the arbitrary IDs 24 to actual user IDs from the identification records (step 316). The identification server 22 accesses the user preferences of each user, and returns to the requesting entity 28 a list of user IDs of users willing to share their presence information for that particular media item (step 318). In one embodiment, the co-presence service 16 may require that the query from the entity 28 contain user credentials necessary for accessing the presence information for a particular media item. This may be more relevant where the entity 28 is a user viewing images through a standard Web Browser.

In one embodiment, the media records 26 maintained by the media record server 20 may exist indefinitely—such that the presence information in the media records 26 may always be available in response to a query using the media record IDs. However, one safeguard to this is that the identities of the users in the media records 26 are hidden using the arbitrary IDs 24 such that the user's real identities are unknown to the identification server 22.

Another safeguard is that the co-presence service 16 periodically updates the peer list 404 in the media records 26 based on the user preferences that control how the users' presence information is to be persisted in the media records 26 (step 320). In one embodiment, the users may configure their preferences by accessing a configuration page of the co-presence service 16 via a browser and define a term and a context in which the user's dynamic arbitrary IDs 24 are mapped to the user's identification.

For example, a user may configure his or her user preferences to enable the sharing of the user's actual ID in response to a query, but specify that any presence information relating to the user is to “time out” and be removed 20 days after the presence information is associated with a media item. After the specified 20 days, the co-presence service 16 removes the mapping within the user's identification record that maps the arbitrary ID 24 back to his actual identification information within the identification server 22.

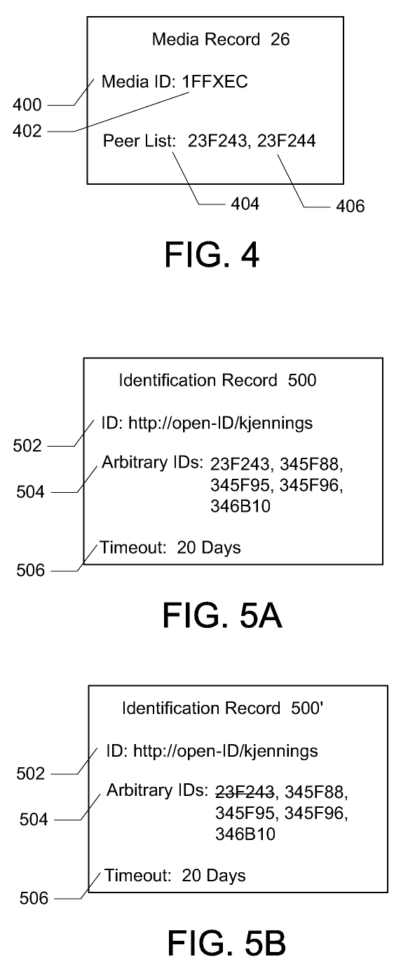

FIGS. 5A and 5B are diagrams illustrating an exemplary identification record maintained by the identification server 22. FIG. 5A shows an identification record 500 of a registered user. The identification record 500 may include an ID field 502 for storing actual identification information, which is shown here as an open-ID of “http://open-ID/kjennings”, an arbitrary ID field 504 for storing arbitrary IDs generated for the user, and a timeout field 506 for storing a term entered by the user controlling how long the presence information is to persist, shown here as 20 days.

FIG. 5B shows the verification record 500′ after the specified 20 day timeout term. In this example, the first listed arbitrary ID 504 of “23F243” was created 20 days prior, and is thus deleted by the co-presence service 16. Consequently, any subsequent query based on a media ID record in which the arbitrary ID 504 of “23F243” is listed, will fail to be mapped back to the user because the arbitrary ID field 502 in user's identification record 500 no longer contains that value.

According to the exemplary embodiment, other methods may be used for managing the persistence of a user's presence information, including but not limited to: location, number of uses (if used across multiple media), and time of existence of media records referencing the particular arbitrary ID.

One benefit of having server-side management of presence information by updating user identification records 500 based on user preferences includes the ability to terminate the association of the user's presence information with media items without requiring the user to remove or disable any software on their media or peer devices 12 and 14.

The foregoing principals will now be further explained by way of a use case example. The exemplary use case serves to illustrate a possible high level use of the system. Although the use cases describe some functionality of a social network that may or may not exist, the use case is disclosed to depict the usefulness of the present invention: Johnny and Sally are traveling with a group of friends to Las Vegas for spring break. They each have camera phones that are enabled with the client application for associating co-presence information with media items, as described above. They have also both created accounts with the co-presences service 16 for presence sharing of media. This option was presented to them via a mechanism in their favorite social network, e.g., Facebook.

1. Johnny spots a great photo-op with the statue in front of Caesar's Palace, and quickly tells the group to gather together before snapping a picture with his camera phone.

2. His camera phone automatically embeds geo-tag information (using known methods) as well as a media record ID retrieved from the co-presence service 16.

3. As Sally also has a new camera phone, her device receives a message over Bluetooth from Johnny's camera phone containing the media record ID for the picture he just took.

4. The client application on Sally's camera phone recognizes the message, and reports to the co-presence service 16 that it has received this particular media record ID.

5. The co-presence service 16 updates the media record for the media item to include in the media record's peer list an arbitrary ID generated for Sally (as described above).

6. Johnny's camera phone has a feature that automatically uploads the picture to his profile on a social network site (e.g., Facebook). The social network site extracts the media ID from the picture and queries the co-presence service 16 to retrieve the names of the co-present people, including Sally. (These were others who were nearby when the picture was taken, and who's settings allow for their presence information to be shared).

7. Later, Sally opens her account on the social network site and is presented with a dialogue showing the picture that Johnny had taken and that affords her the opportunity to tag the people in the photograph.

8. Sally is presented with a subset of names (an intersection of the people tagged as co-present, and her own friend network) as suggestions for people who may be in the photograph.

9. After tagging the people she knows in the picture, Sally is presented with a list of other people associated with this photograph that she might want to consider adding as friends.

Note, that Sally is not presented with the names of people in the photo or in a nearby the location of the photo if those people configured their user preferences for non-sharing of their presence information or whose presence information has timed out, thereby giving users full control over how their presence information is shared and persisted.

A method and system for associating co-presence information with a media item has been disclosed. The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

1. A computer-implemented method for associating co-presence information with a media item, comprising:
in response to a media device acquiring a media item, creating a media identification (ID) for the media item;
broadcasting the media ID to at least one peer device co-present with the media device;
receiving a transmission from a registered user of the peer device reporting receipt of the media ID;
creating an arbitrary ID for the registered user; and
associating with the media item the arbitrary ID of the registered user of the peer device that reported receipt of the media ID.

2. The method of claim 1 further comprising creating a new arbitrary ID for the registered user each time the peer device of the registered user reports receipt of a new media ID.

3. The method of claim 1 further comprising receiving a query for information about the media item, identifying the arbitrary ID associated with the media item, and identifying the registered user that corresponds to the arbitrary ID.

4. The method of claim 1 wherein creating the arbitrary ID further comprises storing a peer device ID for the peer device of the registered user; using the peer device ID of the peer device for which the transmission was received to find the corresponding registered user; and creating the arbitrary ID for the registered user.

5. The method of claim 1 wherein associating the arbitrary ID with the media item further comprises updating a media record containing the media ID of the media item with the arbitrary ID of the registered user.

6. The method of claim 1 wherein in response to the media device acquiring the media item further comprises the media device requesting the media ID from a co-presence service, and the co-presence service creating and returning the media ID to the media device.

7. The method of claim 6 further comprising the media device embedding the media ID in metadata of the media item.

8. The method of claim 1 wherein in response to the media device acquiring the media item further comprises the media device creating the media ID.

9. The method of claim 1 wherein the media device broadcasts the media ID to the peer device.

10. The method of claim 1 wherein a co-presence service broadcasts the media ID to the peer device and receives the transmission from the registered user of the peer device.

11. A system, comprising:
a media device that acquires a media item and communicates over a network; and
a co-presence service accessible over the network that associates co-presence information with the media item by:
in response to a request from the media device, creating a media identification (ID) for the media item and returning the media ID to the media device, wherein the media device broadcasts the media ID to at least one peer device co-present with the media device;
receiving a transmission from a registered user of the peer device reporting receipt of the media ID;
creating an arbitrary ID for the registered user; and
associating with the media item the arbitrary ID of the registered user of the peer device that reported receipt of the media ID.

12. The system of claim 11 wherein the co-presence service creates a new arbitrary ID for the registered user each time the peer device of the registered user reports receipt of a new media ID.

13. The system of claim 11 wherein in response to receiving a query for information about the media item, the co-presence service identifies the arbitrary ID associated with the media item, and identifies the registered user that corresponds to the arbitrary ID.

14. The system of claim 11 wherein the co-presence service stores a peer device ID for the peer device of the registered user; uses the peer device ID of the peer device for which the transmission was received to find the corresponding registered user; and creates the arbitrary ID for the registered user.

15. The system of claim 11 wherein the co-presence service associates the arbitrary ID with the media item by updating a media record containing the media ID of the media item with the arbitrary ID of the registered user.

16. The system of claim 11 wherein the media device requests the media ID from the co-presence service, and the co-presence service creates and returns the media ID to the media device.

17. The system of claim 16 wherein the media device embeds the media ID in metadata of the media item.

18. The system of claim 11 wherein the media device receives the media ID from the co-presence service and broadcasts the media ID to the peer device.

19. The system of claim 11 wherein the co-presence service broadcasts the media ID to the peer device.

20. A media device, comprising:
a memory;
a processor coupled to the memory; and
a client application executed by the processor that is configured to:
acquire a media item and associate a media identification (ID) with the media item, and
broadcast the media ID to at least one peer device co-present with the media device, wherein the peer device sends a transmission to a co-presence service to report receipt of the media ID, wherein the co-presence service creates an arbitrary ID for the registered user and associates with the media item the arbitrary ID of the registered user of the peer device that reported receipt of the media ID.

21-22. (canceled)
